(19) United States
(12) Patent Application Publication
(10) Pub. No.: US 2006/0168133 A1
(43) Pub. Date: Jul. 27, 2006

(54) Apparatus and method for transmitting MPEG content over an internet protocol network

(75) Inventors: Jeong-Rok Park, Hwaseong-si (KR); Kwan-Lae Kim, Yongin-si (KR); Jeong-Seok Choi, Seoul (KR); Chang-Sup Shim, Seoul (KR); Do-Hun Cha, Suwon-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/272,321

(22) Filed: Nov. 10, 2005

(30) Foreign Application Priority Data
Dec. 7, 2004 (KR) 2004-102465

(51) Int. Cl. G06F 15/16

(52) U.S. Cl. 709/219

(57) ABSTRACT

A method for transmitting packetized multimedia content over a network is disclosed. The method comprises, receiving packetized multimedia content to be transmitted over the network; classifying respective frame of the packetized multimedia content according to an assigned priority by analyzing a frame header of each frame of the packet; separately storing the classified frames in accordance with said classification; and differentially marking the classified frames according to quality-of-service (QoS).

### CLAIM OF PRIORITY

This application claims the benefit under 35 U.S.C. §119(a) of an application entitled “Apparatus and Method for Transmitting MPEG Contents over Internet Protocol Network,” filed in the Korean Intellectual Property Office on Dec. 7, 2004 and assigned Serial No. 2004-102465, the entire contents of which are hereby incorporated by reference.

### BACKGROUND OF THE INVENTION

1. Field of the Invention

The present invention relates generally to a system for transmitting multimedia content over a network, and in particular, to a method and apparatus for transmitting multimedia content in a guaranteed quality-of-service (QoS) class.

2. Description of the Related Art

Recent developments in computer and wired/wireless communication technologies have spurred an increase in the transmission of high-quality digital media content, such as, for example, digital broadcasting and DVD. In this regard, many additional applications and programs for reproducing such high-quality digital media content are being proposed, thereby increasing the demand for high-quality digital media content services. The compression standard for high-quality digital media content services is provided by the Moving Picture Experts Group (MPEG).

FIG. 1 is a prior-art diagram illustrating an apparatus for transmitting multimedia content.

FIG. 2 is a prior-art diagram illustrating a problem that may occur during transmission of high-capacity multimedia content in the network apparatus of FIG. 1. Specifically, for a multimedia service, a terminal apparatus accesses a multimedia content service provider via an internet protocol (IP) network. The multimedia content service provider connects with a network apparatus, such as the network apparatus shown in FIG. 1, and transmits multimedia content to the network apparatus. The network apparatus is connected to a terminal apparatus over the network. The network apparatus includes a router or a multimedia content streamer. Accordingly, a communication path is established whereby the network apparatus links the multimedia content service provider with terminal apparatus, via the network apparatus, to transmit and receive the multimedia content. The multimedia content transmitted from the multimedia content service provider typically comprises high-capacity data streams. The network over which the multimedia content is transmitted is assumed to have a limited bandwidth. This is problematic in that the network must provide various kinds of multimedia content having different delay characteristics necessitating a wide bandwidth. A further drawback is that in the process of transmitting burst content, the network often generates congestion events, causing a loss of data. A “congestion event” refers to an event in which data congestion occurs in a boundary router. For example, high-capacity MPEG content may be presented to the network for transmission from a multimedia content provider to a terminal apparatus. When the MPEG content transmitted from the multimedia content provider exceeds the capacity of the data communication path, a “congestion event” occurs. Traffic is concentrated on the network apparatus, causing the communication path to reach its capacity limit. To resolve such “congestion” occurrences, there have been proposals in the prior art of a differentiated service for guaranteeing a differentiated quality of service (QoS) based on a traffic characteristic of the multimedia content.

To support a differentiated quality of service (QoS), the network apparatus would further include a marker 100, as shown in FIG. 1, to establish an additional packet field, referred to as a differentiated service code point (DSCP) field for a transmission packet. The DSCP field indicates a drop precedence for randomly discarding data, whenever a “congestion event” occurs. In operation, a marker 100 marks multimedia data 10 (MPEG Data) provided from a multimedia content provider before transmitting the multimedia data 10 to a network terminal apparatus taking into account a service level contract between the terminal apparatus and the multimedia content service provider. This solution, however, is not without drawbacks.

As shown in FIG. 2, if congestion occurs in a Multi-layer switch, the network receives only 100 Mbps of data, corresponding to its own communication path, and randomly discards the remaining 900 Mbps of data, without taking into consideration the priority level of the 900 Mbps of discarded data.

Therefore, it is shown that the existing prior art solution to overcome “congestion events” and delays is deficient in that whenever a “congestion event” or delay occurs, during a data transmission, MPEG content is randomly discarded without considering the priority level of the discarded data.

Generally, MPEG content is derived by compressing an original moving image. A picture is divided into frames before being compressed. Specifically, frames are classified as I-frames, B-frames and P-frames, each of which has a different priority needed to reproduce an image. Among the various frame types, the I-frame has the highest priority. It is noted, however, that the prior art approach for overcoming “congestion events” and delays does not consider the relative frame prioritizations when MPEG content is being randomly discarded. This results in inefficient and undesirable image reproduction. Relative prioritization is not taken into consideration because the marker 100 is unable to distinguish frame types for marking purposes when transmitting MPEG content over the network.

### SUMMARY OF THE INVENTION

Accordingly, the present invention provides an apparatus and method for efficiently transmitting multimedia content over an Internet protocol (IP) network. This is largely achieved by prioritizing the multimedia content prior to transmitting the content over the network. Prioritization is implemented by differentially marking frames of the video content taking the overall network bandwidth into consideration.

According to one aspect of the present invention, there is provided a method for transmitting multimedia content over a network. The method includes the steps of: receiving the packetized multimedia content to be transmitted over the network; classifying respective frames of the packetized multimedia content according to an assigned priority by analyzing a frame header of each frame of the packet; and separately storing the classified frames in accordance with said classification; and differentially marking the classified frames according to quality-of-service (QoS).

According to another aspect of the present invention, there is provided a method for transmitting multimedia content over an Internet protocol (IP) network. The method comprising the steps of, determining a packet type of the multimedia content by analyzing a header of the moving image content to be transmitted; classifying pictures according to an assigned priority by analyzing a field indicating a picture type of the packet, storing the classified pictures; and marking the classified pictures with differentiated values before transmission.

According to another aspect of the present invention, there is provided an apparatus for transmitting multimedia content over a network. The apparatus comprises an extractor for receiving packetized moving image content to be transmitted, and classifying frames according to an assigned priority by analyzing a header of the moving image content; a plurality of buffers for separately storing the classified frames; a marker for marking the classified frames with differentiated codes according to the assigned priority; and a quality-of-service (QoS) management block for generating the codes differentiated for the individual frames taking a condition of the network into consideration.

According to yet another aspect of the present invention, there is provided an apparatus for transmitting moving image contents over an Internet protocol network. The apparatus comprises

an extractor for determining a packet type of the moving image content by analyzing a header of the moving image content to be transmitted;

a plurality of buffers for separately storing pictures according to an assigned priority by analyzing a field indicating the picture type; and

a marker for marking the classified pictures with differentiated codes according to the assigned priority.

### BRIEF DESCRIPTION OF THE DRAWINGS

FIG. 1 is a diagram schematically illustrating an apparatus for transmitting multimedia content over a network according to the prior art;

FIG. 2 is a diagram illustrating a data congestion problem that may occur during transmission of high-capacity multimedia content in the apparatus of FIG. 1;

FIGS. 3A and 3B are diagrams illustrating a frame format and a packet format for the multimedia content suitable for use with the invention;

FIG. 4 is a diagram illustrating a packet format for a differentiated service;

FIG. 5 is a diagram schematically illustrating an apparatus for transmitting the multimedia content according to an embodiment of the present invention; and

FIG. 6 is a flowchart illustrating an operation of transmitting the multimedia content according to an embodiment of the present invention.

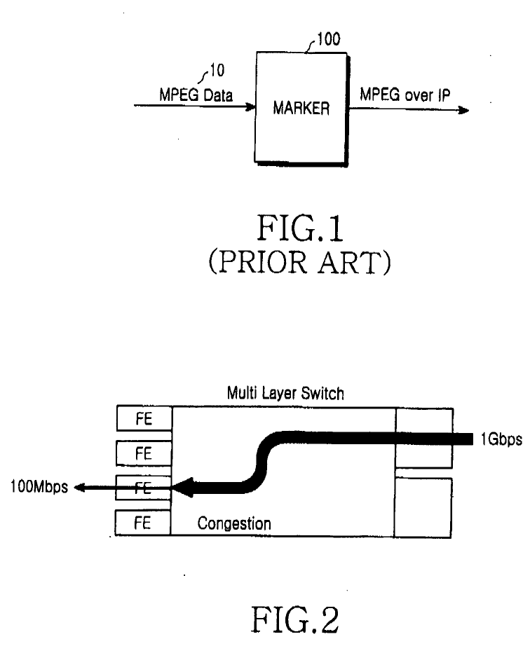

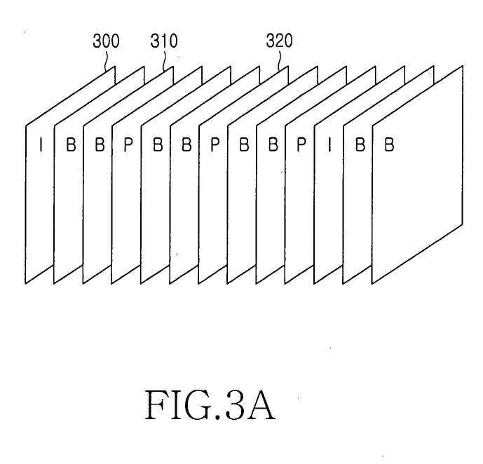

### DETAILED DESCRIPTION

Several exemplary embodiments of the present invention will now be described in detail with reference to the annexed drawings. In the drawings, the same or similar elements are denoted by the same reference numerals even though they are depicted in different drawings. For the purposes of clarity and simplicity, a detailed description of known functions and configurations incorporated herein has been omitted for clarity and conciseness.

The present invention provides an apparatus and method for efficiently transmitting multimedia content for a multimedia service over limited bandwidth networks. The present invention provides significant advantages over the prior art by optimally transmitting the multimedia content by distinguishing (prioritizing) individual frames of the multimedia content. Specifically, each frame of multimedia content to be transmitted over a limited bandwidth network is individually marked with an assigned differentiating code, prior to transmission. In this manner, the present invention guarantees a quality of service (QoS) of the MPEG content discarding frames in accordance with the assigned differentiating code, taking the bandwidth of the network into account.

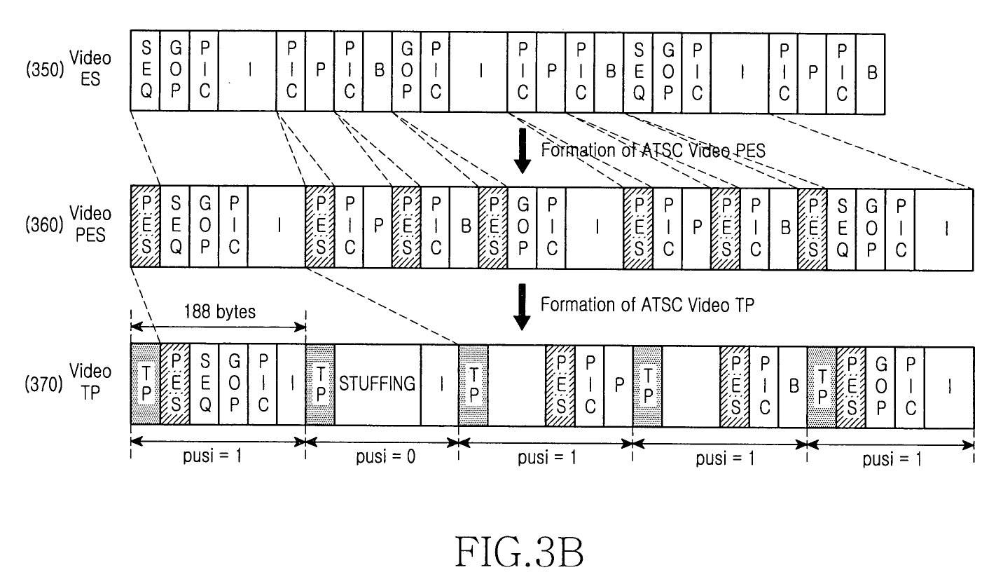

Referring now to FIG. 3A, there is shown a diagram schematically illustrating multimedia content comprised of a plurality of MPEG frames to which the present invention is applicable.

As briefly described above, an MPEG video stream is divided into three kinds of frames for purposes of compressing a moving image. The frames are distinguished according to their priorities at a reception side (or terminal apparatus) to reproduce the image. Specifically, the frames are classified as Intra (I) picture frames 300 for removing redundancy in the current frame, Predictive (P) picture frames 310 for removing time redundancy with a previous frame and redundancy in the frame, and Bidirectional predictive (B) picture frames 320 for removing time redundancy with a previous frame or a next frame and redundancy in the frame. It is noted that the Intra-picture frame, otherwise referred to as an I-picture frame, has the highest priority of the three frame types.

As is well-known, the frames can be configured in various ways according to a parameter ‘n’ indicting the number of frames in a group-of-pictures (GOP) and a parameter ‘M’ indicting an interval between P-pictures. To illustrate the principles of the invention, exemplary group-of-pictures are configured in FIG. 3 in the following order:
I-B-B-P-B-B-P-B-B-P-I-B-B.

FIG. 3B is a diagram illustrating a process of packetizing MPEG frames before transmission according to the frame configuration of FIG. 3A, described as follows.

Referring to FIG. 3B, a video elementary stream (Video ES) 350 comprises digital data generated by encoding and compressing analog video multimedia content. A basic elementary stream (ES) is generated for each content category (e.g., audio, video and data). For example, an audio encoder generates an audio elementary stream (ES), and a video encoder generates a video elementary stream (ES). An elementary stream (ES) can be, for example, a digital data stream generated by encoding and compressing the contents of a transmission TV program. The encoded and compressed ES includes sequence-of-picture (SEQ) fields, GOP fields, PIC fields indicting a type of a corresponding picture inserted herein later.

With continued reference to FIG. 3B, the generated ES (e.g., Video ES) 350 is converted into a packetized elementary stream (Video PES) 360 through a packetization process. As shown in FIG. 3B, the Video PES 360 is distinguishable from the Video ES 350 in that it further includes a packet header PES generated by the packetization process.

Thereafter, the Video PES 360 is multiplexed into a transport stream (TS) 370 which is in a transmittable format. To generate the transport stream (TS) 370, a video PES and an audio PES are multiplexed with synchronization data. The transport stream (TS) 370 further includes a transport header TP generated by the multiplexing process before being transmitted.

It is therefore shown that an MPEG media transport packet, such as TS 370, transmitted through an IP network includes, inter alia, headers corresponding to respective layers of the encoding process, the compression process and the packetization process. As a consequence of adding the various headers, the MPEG media transport packet is configured into a data stream having a longer length than the elementary stream from which it was derived (i.e., Video ES 350).

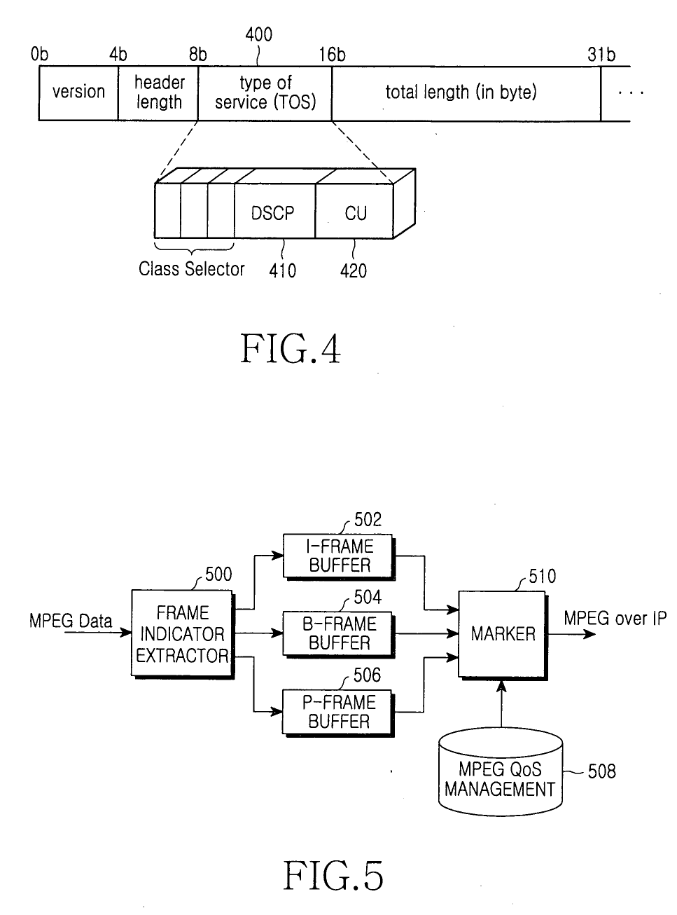

In general, the MPEG media transport packets (e.g., Video TP 370) are transmitted over the IP network. It should be noted, however, that the packets require a high-capacity bandwidth in a limited bandwidth IP network which makes the packets vulnerable to data loss due to delay and collision. In order to prevent or minimize such data loss, the present invention provides a novel differentiated service, described as follows with reference to FIGS. 4-6.

FIG. 4 illustrates an IPv4 packet format in a network supporting a differentiated service to which the present invention is applicable. The differentiated service efficiently uses the limited bandwidth available in a network to support a multimedia service operated over an Internet protocol (IP) network. The differentiated service divides traffic transmitted and received through the network into several classes, and provides services differentiated according to the several classes.

Multimedia content transmitted from a multimedia service provider typically involves the transmission of a large volume of multimedia content using a wide frequency band. However, a network, operated in accordance with the Internet protocol, only supports a limited bandwidth, thereby necessitating that a video content service, operating over the network, requiring a wide frequency band, be restricted to a low quality of service (QoS) level. For example, a mobile communication network supporting a mobile phone and a notebook computer supports a multimedia content service with a maximum bandwidth of 144 Kbps. In contrast to the mobile communication network, a multimedia broadcasting service supported by a wireless local area network (LAN) and the wired Internet requires a maximum bandwidth of 10 Mbps. The difference in bandwidth between the network and the broadcasting service illustrates, by example, the problems that can arise where different video and audio content standards coexist. To overcome such problems, the method of the invention provides for differentiated service classes for classifying IP traffic into a limited number of service classes taking into account the QoS of the multimedia content.

Therefore, in accordance with principles of the invention, information required to implement service class differentiation in a network includes modifying packet headers to include a type-of-service (TOS) field 400 for an IPv4 packet or a traffic class (TC) field for an IPv6 packet.

As shown in FIG. 4, the IPv4 packet is comprised of 32 bits (0b-31b). In the IPv4 packet, a ‘version’ field is comprised of 4 bits (0b-4b). This field indicates a version state of the IP packet. That is, the ‘version’ field indicates whether the packet is an IPv4 packet or an IPv6 packet. Following the ‘version’ field, there is shown a ‘header length’ field. The ‘header length’ field is shown to be comprised of 4 bits (4b-8b) and indicates the total length of a header of the packet. Following the ‘header length’ field, there is shown a TOS field 400. The TOS field 400 is shown to be comprised of 8 bits (8b-16b) and indicates the current service type of the network. In an embodiment of the present invention, the TOS field 400 includes a 6-bit DSCP field 410 indicating the differentiated service and a 2-bit reserved field 420. The 6-bit DSCP field 410 indicates a packet delivery function based on the differentiated service. In an embodiment of the present invention, the higher 3 bits in the 6-bit DSCP field 410 are used as class selectors for distinguishing I-frames, B-frames and P-frames of the MPEG content.

FIG. 5 is a block diagram illustrating the structure of an apparatus for transmitting multimedia content, according to an embodiment of the present invention.

The MPEG content is transmitted over an IP network from a service provider through an IP path connecting an end router of the network (or an IP streamer) to an end router of a terminal apparatus side. Herein, the MPEG frames of the MPEG content include I-frames, B-frames and P-frames, and the priority in reproducing an image is higher in the order: A method for transmitting packetized multimedia content over a network includes: receiving packetized multimedia content to be transmitted over the network; classifying respective frame of the packetized multimedia content according to an assigned priority by analyzing a frame header of each frame of the packet; separately storing the classified frames in accordance with said classification; and differentially marking the classified frames according to quality-of-service (QoS), whereby I-frames having the highest priority, the P-frames having the next highest priority and the B-frames having the lowest priority.

With continued reference to FIG. 5, upon detecting MPEG content (i.e., MPEG data) input transmitted from a service provider, an MPEG frame indicator extractor 500 classifies frame indicators of the MPEG content in a prescribed order by analyzing the frame headers of each frame, and storing the I-frames, B-frames and P-frames into separate packet classification buffers 502, 504 and 506, according to classification.

A marker 510 performs DSCP marking using differentiated codes set in accordance with the frame priorities. That is, the marker 510 applies one type of DSCP marking code to frames stored in the I-Frame buffer 502, a second type of DSCP marking code to frames stored in the B-Frame buffer 504 and a third type of DSCP marking code to frames stored in the P-Frame buffer 506.

An MPEG QoS management information block 508, operatively coupled to the marker 510, stores the priority information of the frame indicators extracted by the MPEG frame indicator extractor 500.

That is, in the process of transmitting the MPEG frames over the IP network, the marker 510 marks the individual MPEG frames taking into consideration priority information of the individual MPEG frames, stored in the MPEG QoS management information block 508. By marking the frames in this manner, frames are discarded in accordance with the priority of their associated DSCP values when congestion occurs in the network. The MPEG QoS management information block 508 can store the DSCP values for the frames and adjust the stored DSCP values according to the prevailing network conditions.

In operation, when congestion occurs in the network as described above, a router of the network determines packet processing priorities depending on the marked DSCP values. In other words, the network router guarantees QoS of individual frames for the MPEG content, thereby allowing QoS of the I-frame to be always higher than QoS of the P-frame or the B-frame. In this manner, data loss is minimized by minimizing the discarding of I-frames having the highest priority, thereby guaranteeing video QoS.

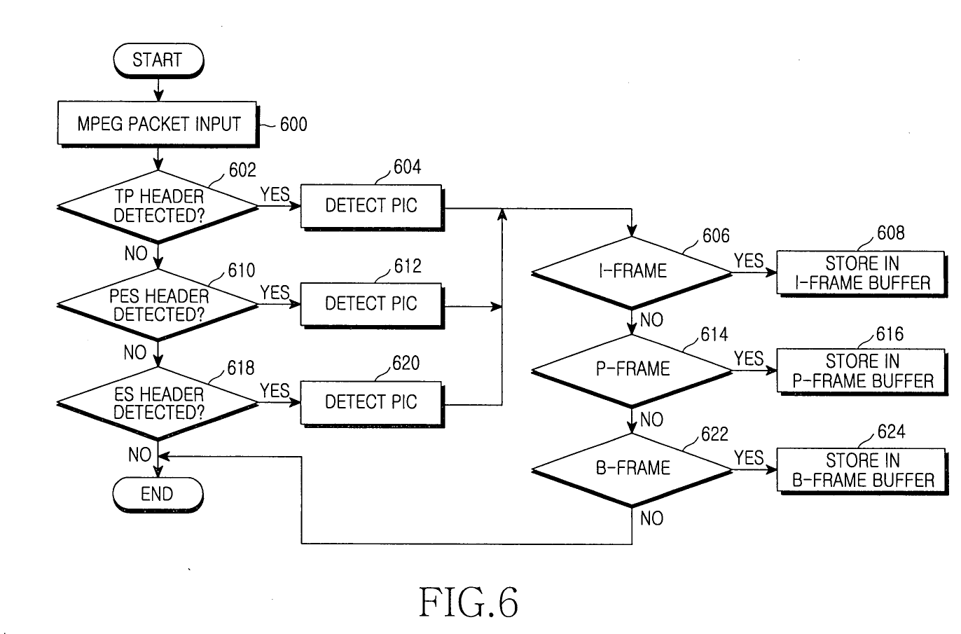

FIG. 6 is a flowchart illustrating a method of transmitting multimedia content according to an embodiment of the present invention.

Referring to FIG. 6, in step 600, an MPEG frame indicator extractor 500 detects an input of an MPEG packet to be transmitted through the network using the Internet protocol. It is noted that the MPEG frame indicator extractor 500 is a type of parser. As is well known, a parser is a part of a compiler that receives a command word or a mark-up tag, and processes the received command word or mark-up tag using another program.

After detecting the input of an MPEG frame, the MPEG frame indicator extractor 500 analyzes the packet type of the received MPEG frame. As discussed above, MPEG content transmitted from a multimedia content service provider can include different types of elementary streams including a video elementary stream (video ES), a video packetizer elementary stream (video PES) and a video transport stream (video TS). Therefore, the MPEG frame indicator extractor 500 can classify corresponding MPEG frames in the packet types by parsing the types of the MPEG contents.

In addition, as illustrated in FIG. 3B, the video elementary stream (video ES), video packetizer elementary stream (video PES) and the video transport stream (video TS) are each comprised of packets by dividing each of the I-frame, the B-frame and the P-frame. Therefore, it is possible to determine whether a corresponding frame is an I-frame, a B-frame or a P-frame by parsing a PIC field located in a front stage of each of the I-frame, the B-frame and the P-frame.

In step 602, the MPEG frame indicator extractor 500 determines whether a video packet type is ES, PES or TP. More particularly, the MPEG frame indicator extractor 500 detects a TP header of the MPEG frame and determines whether the MPEG frame is a TS which is a packet with an IP transport format. The TS is detected by checking whether a TP header of ‘0x47’ is received every 188 bytes.

In step 604, the MPEG frame indicator extractor 500 detects a position of a PIC field by activating a counter, and then determines the frame type by reading the PIC field.

In step 606, the MPEG frame indicator extractor 500 determines whether the MPEG frame is an I-frame. If the MPEG frame is an I-frame, the MPEG frame indicator extractor 500 stores the I-frame in an I-frame buffer 502 in step 608. However, if the MPEG frame is not an I-frame, the MPEG frame indicator extractor 500 determines in step 614 whether the MPEG frame is a P-frame. If the NPEG frame is a P-frame, the MPEG frame indicator extractor 500 stores the P-frame in a P-frame buffer 504 in step 616. However, if the MPEG frame is not the P-frame, the MPEG frame indicator extractor 500 determines in step 622 whether the MPEG frame is a B-frame. If the MPEG frame is a B-frame, the MPEG frame indicator extractor 500 stores the B-frame in a B-frame buffer 506 in step 624.

However, if it is determined in step 602 that the TP header is not ‘0x47’, the MPEG frame indicator extractor 500 determines in step 610 whether the MPEG frame is a PES packet. If the MPEG frame is a PES packet, the MPEG frame indicator extractor 500 detects in step 612 a position of a PIC field by activating a counter, and then reads the PIC field. Thereafter, in step 606, the MPEG frame indicator extractor 500 determines the MPEG frame type, and stores the MPEG frame in a corresponding frame buffer according to the determination result.

However, if it is determined in step 610 that the MPEG frame is not a PES packet, the MPEG frame indicator extractor 500 determines in step 618 whether a SEQ field in its packet header is 0x0000,01B3. If the MPEG frame is an ES packet, the MPEG frame indicator extractor 500 detects in step 620 a position of a PIC field by activating a counter, and then reads the PIC field. Thereafter, in step 606, the MPEG frame indicator extractor 500 determines the MPEG frame type, and stores the MPEG frame in a corresponding frame buffer according to the determination result.

If it is determined in step 602 that the MPEG frame is not the TS, the MPEG frame indicator extractor 500 proceeds to step 610 where it detects a PES header. Further, if it is determined in step 610 that the MPEG frame is not the PES, the MPEG frame indicator extractor 500 proceeds to step 618 where it detects an ES header, and then determines a transport format by analyzing a PIC field of the ES header, thereby detecting a frame. Thereafter, a marker 510 differentiately marks the stored frames.

As can be understood from the foregoing description, the present invention services the MPEG contents through the Internet protocol by classifying frames according to priority and performing DSCP marking depending on the classification result. That is, when congestion occurs in the network, the present invention discards the packets in the order or a packet having a lower priority taking the DSCP values into consideration, thereby guaranteeing QoS of the MPEG contents. Therefore, the present invention efficiently provides the MPEG content service.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for transmitting packetized multimedia content over a network, the method comprising the steps of:
receiving the packetized multimedia content to be transmitted over the network;
classifying respective frame of the packetized multimedia content according to an assigned priority by analyzing a frame header of each frame of the packet;
separately storing the classified frames in accordance with said classification; and
differentially marking the classified frames according to quality-of-service (QoS).

2. The method of claim 1, wherein the step of separately storing the classified frames, further comprises separately storing the classified frames in associated packet classification buffers.

3. The method of claim 1, wherein a bandwidth of the network is considered when differentially marking the classified frames according to QoS.

4. A method for transmitting multimedia content over an Internet protocol network, the method comprising the steps of:
determining a packet type of the multimedia content by analyzing a header of the moving image content to be transmitted;
classifying pictures according to an assigned priority by analyzing a field indicating a picture type of the packet,
storing the classified pictures; and
marking the classified pictures with differentiated values before transmission.

5. The method of claim 4, further comprising the step of marking an intra picture with a value guaranteeing a highest quality-of-service (QoS) according to priority before transmission.

6. The method of claim 4, further comprising the steps of:
assigning a service type field of an Internet protocol header of the multimedia content as a differentiated service code point (DSCP) field; and
marking the DSCP field with a differentiated value before transmission.

7. An apparatus for transmitting multimedia content over a network, the apparatus comprising:
an extractor for receiving packetized multimedia content to be transmitted, and classifying frames according to priority by analyzing a header of the multimedia content;
a plurality of buffers for separately storing the classified frames;
a marker for marking the classified frames with differentiated codes according to the priority; and
a quality-of-service (QoS) management block for generating the codes differentiated for the individual frames taking a condition of the network into consideration.

8. An apparatus for transmitting multimedia content over an Internet protocol network, the apparatus comprising:
an extractor for determining a packet type of the multimedia content by analyzing a header of the moving image content to be transmitted;
a plurality of buffers for separately storing pictures according to an assigned priority by analyzing a field indicating the picture type; and
a marker for marking the classified pictures with differentiated codes according to the priority.

9. The apparatus of claim 8, wherein one of said plurality of buffers is an intra-picture buffer for removing redundancy in the current frame.

10. The apparatus of claim 8, wherein one of said plurality of buffers is a predictive-picture buffer for removing time redundancy with a previous frame and redundancy in the current frame.

11. The apparatus of claim 8, wherein one of said plurality of buffers is a bidirectional predictive-picture buffer for removing time redundancy with a previous frame or a next frame and redundancy in the current frame.

12. The apparatus of claim 8, wherein the marker marks each classified picture with a differentiated code according to the priority taking a condition of the Internet protocol network into consideration.

13. The apparatus of claim 12, wherein the each of the differentiated codes used to mark each classified picture indicates a particular quality-of-service (QoS) classified according to picture priority, wherein the differentiated codes are stored in a QoS management block.

14. The apparatus of claim 13, wherein the marker marks a priority of an intra picture for removing redundancy in the current frame with a differentiated code indicating the highest QoS.
